(19) United States
(12) Patent Application Publication
(10) Pub. No.: US 2026/0370397 A1
(43) Pub. Date: Nov. 19, 2026

(54) UE-SELECTED OPERATION DIRECTION FOR UE WITH HARQ FEEDBACK DISABLING

(71) Applicant: Nokia Technologies Oy, Espoo (FI)

(72) Inventors: Jingyuan SUN, Beijing (CN); Tzu-Chung HSIEH, Hoffman Estates, IL (US); Gilsoo LEE, Lisle, IL (US); Mads LAURIDSEN, Gistrup (DK); Ping YUAN, Beijing (CN)

(21) Appl. No.: 19/103,257

(22) PCT Filed: Aug. 12, 2022
(86) PCT No.: PCT/CN2022/111982

§ 371 Date: Feb. 12, 2025

(51) Int. Cl. H04L 1/1829; H04L 1/1812

(52) U.S. Cl. CPC H04L 1/1864; H04L 1/1812

(57) ABSTRACT

A UE is configured to receive a set of repetitions of a downlink message from a base station and attempt to decode the DL message after receiving one or more of the repetitions. If decoding is successful, then the UE transmits an uplink message (e.g., a HARQ-ACK) indicating successful decoding. If decoding is not successful, then the UE does not transmit an uplink message indicating unsuccessful decoding. If the set is not completed, then the UE receives one or more additional repetitions and again attempts to decode the DL message. If the base station receives the UL message indicating successful decoding before transmitting all of the repetitions in the set, then the base station stops transmitting repetitions. For half-duplex UEs with HARQ feedback processing disabled, upon successful decoding, the UE switches from downlink mode to uplink mode to transmit the uplink message, thereby avoiding processing of subsequently received repetitions for that same downlink message.

### TECHNICAL FIELD

The present disclosure relates to communication systems.

### BACKGROUND

This section introduces aspects that may help facilitate a better understanding of the disclosure. Accordingly, the statements of this section are to be read in this light and are not to be understood as admissions about what is prior art or what is not prior art.

In a communication system, it is known for a downstream node to transmit an uplink (UL) message back to an upstream node acknowledging the receipt of a previously transmitted downlink (DL) message and indicating whether or not the DL message was successfully decoded. If the DL message was not successfully decoded, then the downstream node uses the UL message to request retransmission of the DL message.

For example, in a wireless network it is known for user equipment (UE) to transmit an uplink Hybrid Automatic Repeat request (HARQ) message to a base station acknowledging receipt of a previously transmitted Physical Downlink Shared CHannel (PDSCH) message. If the UE successfully decodes the PDSCH message, then the UE transmits a HARQ-ACK message to the base station indicating successful decoding of the PDSCH message. If the UE does not successfully decode the PDSCH message, then the UE transmits a HARQ-NACK message to the base station indicating that the PDSCH message was not successfully decoded, in which case the base station will re-transmit the PDSCH message.

In environments with relatively high probability of unsuccessful decoding of individual PDSCH messages, it is known for a base station to send a PDSCH message to a UE by transmitting a continuous set containing multiple repetitions of the PDSCH message to increase the probability of successful decoding at the UE. In that case, the UE will wait until after it has received the entire set of repetitions before performing DL processing to attempt to decode the PDSCH message.

It is also known to disable HARQ feedback processing wherein the UE does not transmit any HARQ messages to the base station. In that case, since the base station will not be receiving requests for re-transmission, it is known to increase the number of repetitions of a PDSCH message to increase the probability of successful decoding at the UE.

### SUMMARY

When conventional HARQ feedback processing is disabled in a wireless network and the number of repetitions of a PDSCH message is relatively large, it may be that the relatively large number of repetitions are more than what is needed to successfully decode the PDSCH message at the UE. In that case, the additional repetitions of the PDSCH message are unnecessary, resulting in unnecessarily high latencies and/or unnecessarily low effective bandwidths in the DL and/or UL directions.

These problems in the prior art are addressed in accordance with the principles of the present disclosure by a conditional HARQ feedback scheme in which a base station sends a PDSCH message to a UE by transmitting a set of repetitions of the PDSCH message in multiple subsets possibly separated by gaps of time, where each subset includes one or more repetitions of the PDSCH message, and the UE attempts to decode the PDSCH message following receipt of one or more, but not all, of the subsets of repetitions. If the UE fails to successfully decode the PDSCH message, then the UE will then receive one or more additional subsets without transmitting any HARQ message to the base station. If, however, the UE does successfully decode the PDSCH message, then the UE will transmit a HARQ-ACK message to the base station indicating that the PDSCH message has been successfully decoded. In that case, the base station can terminate its transmission of subsequent subsets for that PDSCH message, thereby enabling the base station, for example, to schedule transmission of another PDSCH message sooner, thereby decreasing latency and increasing bandwidth.

In an implementation in which the UE operates in a half-duplex mode, upon successful decoding of the PDSCH message, the UE will switch from it DL operating mode to its UL operating mode in order to transmit the HARQ-ACK message.

In certain embodiments of the present disclosure, user equipment (UE) comprises at least one processor and at least one memory storing instructions that, when executed by the at least one processor, cause the UE at least to (1) receive a set of repetitions of a downlink (DL) message, the set comprising two or more subsets of the repetitions, each subset comprising one or more of the repetitions; (2) attempt to decode the DL message after receiving one or more of the subsets; (3) if the UE successfully decodes the DL message, then transmit an uplink (UL) message indicating successful decoding of the DL message; and (4) if the UE does not successfully decode the DL message in the current subset, then (i) do not transmit an uplink message indicating unsuccessful decoding of the DL message and (ii) if the set is not completed, then (a) receive an additional one or more of the subsets and (b) again attempt to decode the DL message.

In at least some of the above embodiments, the UE is configured to attempt to decode the DL message based on one or more specified times.

In at least some of the above embodiments, the UE is configured to (i) operate in half-duplex (HD) mode and (ii) stop receiving repetitions of the DL message after successfully decoding the DL message.

In at least some of the above embodiments, the UE is configured to decode the DL message during a gap in time between the start and end of the two or more subsets.

In at least some of the above embodiments, the UE is configured with specified timing for the gap.

In at least some of the above embodiments, the UE is configured to use an UL resource to transmit the UL message.

In at least some of the above embodiments, the UL resource is configured as part of the configuring of the UE to receive the set of repetitions.

In at least some of the above embodiments, the UL message is multiplexed with one or more other UL messages from one or more other UEs using a shared UL resource.

In at least some of the above embodiments, the number of repetitions of the DL message is different for at least two of the subsets.

In at least some of the above embodiments, the UE transmits the UL message while repetitions of the DL message are arriving at the UE.

In certain embodiments of the present disclosure, a base station comprises at least one processor and at least one memory storing instructions that, when executed by the at least one processor, cause the base station at least to (1) be configured to transmit a set of repetitions of a DL message to a UE, the set comprising two or more subsets of the repetitions, each subset comprising one or more of the repetitions and (2) transmit the two or more subsets of the repetitions to the UE while monitoring for an UL message indicating successful decoding of the DL message from the UE.

In at least some of the above embodiments, the base station configures the UE to receive the two or more subsets of the repetitions of the DL message.

In at least some of the above embodiments, the base station configures the UE with one or more specified times to attempt to decode the DL message.

In at least some of the above embodiments, the base station stops transmitting repetitions of the DL message after transmitting one or more of the repetitions in the set, but before transmitting all of the repetitions in the set, after receiving the UL message indicating successful decoding of the DL message.

In at least some of the above embodiments, the base station transmits the repetitions with a gap in time between the start and end of the two or more subsets and the base station configures the UE to attempt to decode the DL message during the gap in time.

In at least some of the above embodiments, the network is a Non Terrestrial Network (NTN).

In at least some of the above embodiments, the base station configures an UL resource to the UE to transmit the UL message and the base station receives the UL message on the UL resource from the UE.

In at least some of the above embodiments, the number of repetitions of the DL message is different for at least two of the subsets.

In at least some of the above embodiments, the UL message is multiplexed with one or more other UL messages from one or more other UEs using a shared UL resource.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified hardware block diagram of a portion of a wireless network of the disclosure in which a base station communicates wirelessly with user equipment (UE);

FIG. 2 is a time diagram representing the transmission of a PDSCH message by the base station of FIG. 1 and the receipt and processing of that message by the UE of FIG. 1 for a first scenario in which the PDSCH message is not successfully decoded at the UE;

FIG. 3 is a time diagram representing the transmission of a PDSCH message by the base station of FIG. 1 and the receipt and processing of that message by the UE of FIG. 1 for a second scenario in which the UE successfully decodes the PDSCH message before the base station has finished transmitting all of its scheduled subsets for that PDSCH message;

FIG. 4 is a flow diagram of the processing of the UE of FIG. 1 according to certain implementations of the disclosure; and

FIG. 5 is a flow diagram of the processing of the base station of FIG. 1 according to certain implementations of the disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

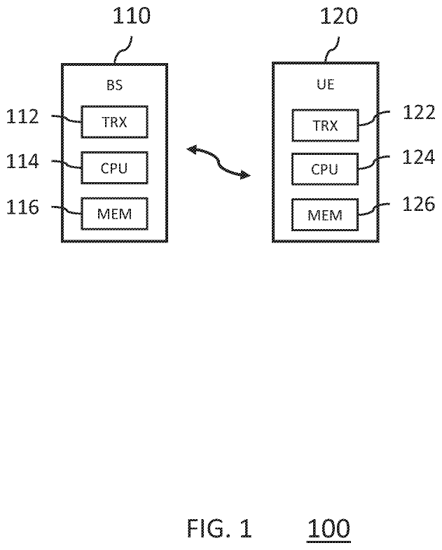

FIG. 1 is a simplified hardware block diagram of a portion of a wireless network 100 in which a base station (BS) 110 (e.g., an eNB for a 4G network/a gNB for a 5G network) communicates wirelessly with user equipment (UE) 120. Those skilled in the art will understand that the network may include other UEs (not shown) that communicate with the BS 110 and that the BS 110 is connected to network infrastructure (not shown) that enables, for example, the UE 120 to communicate with other UEs. In addition, although not shown in FIG. 1, the network 100 may have additional base stations as well as other network elements that support the functionality of the network for communicating with multiple other UEs.

As shown in FIG. 1, the BS 110 includes (i) a wireless transceiver (TRX) 112 for transmitting downlink (DL) wireless signals to and receiving uplink (UL) wireless signals from the UE 120 and (ii) a processor (CPU) 114 for controlling the operations of the BS 110, including the processing of DL and UL messages to and from the UE 120, based on software code stored in the base station's memory (MEM) 116. Analogously, the UE 120 includes (i) a wireless TRX 122 for transmitting UL wireless signals to and receiving DL wireless signals from the BS 110 and (ii) a processor 124 for controlling the operations of the UE 120, including the processing of UL and DL messages to and from the BS 110, based on software code stored in the UE's memory 126. In addition, the BS 110 includes a backend transceiver (not shown) for transmitting and receiving (wired or wireless, depending on the implementation) signals to and from backend network infrastructure (not shown).

In certain implementations, the network 100 of FIG. 1 employs frequency division duplex (FDD) processing in which the BS 110 operates in full-duplex (FD) mode such that the BS 110 is capable to simultaneously transmitting a DL message to the UE 120 and receiving an UL message from the UE 120, but where the UE 120 operates in half-duplex (HD) mode such that, at any given time, the UE 120 can support either DL operation to receive a DL message from the BS 110 or UL operation to transmit an UL message to the BS 110, but not both.

In a particular mode of operation in which conventional HARQ feedback processing is disabled, the BS 110 is configured to send a PDSCH message to the UE 120 by transmitting a sequence of subsets possibly separated by gaps of time, where each subset includes one or more repetitions of the PDSCH message. The UE 120 is configured to attempt to decode the PDSCH message following receipt of one or more, but not all of the subsets. If the UE 120 fails to decode the PDSCH message, then the UE 120 remains in its DL operating mode to receive one or more additional subsets and then attempt to decode the PDSCH message again. This process may continue for the entire set of subsets of repetitions. If and when, however, the UE 120 successfully decodes the PDSCH message, the UE 120 switches to its UL operating mode and transmits a HARQ-ACK message to the BS 110 informing the BS 110 that the PDSCH message has been successfully received. In that case, upon receipt of the HARQ-ACK message, the BS 110 stops transmitting subsets for that PDSCH message.

The UE 120 may transmit the UL message while repetitions of the DL PDSCH message are arriving at the UE 120.

Depending on the implementation, the UL feedback can be for a HARQ feedback process or for a bundling of multiple HARQ feedback processes.

As used herein, the term “repetition” refers to a copy or instance of a message. Note that a single copy or instance of a message in a subset is referred to as a repetition even though the message is not repeated in that subset.

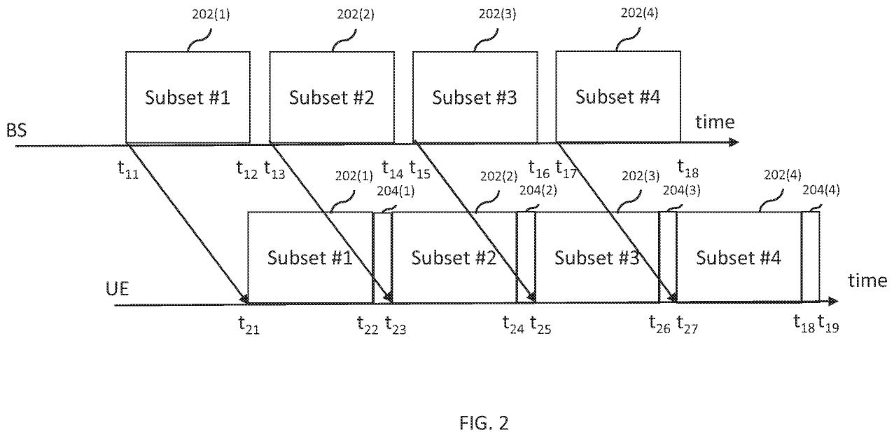

FIG. 2 is a time diagram representing the transmission of a PDSCH message by the BS 110 of FIG. 1 and the receipt and processing of that message by the UE 120 for a first scenario in which the PDSCH message is not successfully decoded at the UE 120. As shown in FIG. 2, from time t11 to time t12, the BS 110 transmits a first subset 202(1) containing one or more repetitions of the PDSCH message. From time t12 to time t13, the BS 110 does not transmit. From time t13 to time t14, the BS 110 transmits a second subset 202(2) again containing one or more repetitions of the PDSCH message. From time t14 to time t15, the BS 110 again does not transmit. From time t15 to time t16, the BS 110 transmits a third subset 202(3) again containing one or more repetitions of the PDSCH message. From time t16 to time t17, the BS 110 again does not transmit. From time t17 to time t18, the BS 110 transmits a fourth subset 202(4) again containing one or more repetitions of the PDSCH message. In this particular scenario, the BS 110 transmits the four subsets 202(1)-202(4) for the PDSCH message. In general, in this scenario, the BS 110 transmits a sequence containing a specified number of subsets separated by gaps of time. In general, the gap can be between subsets of the two or more subsets.

Meanwhile, with the UE 120 configured in its DL operating mode, from time t21 to time t22, the UE 120 receives the first subset 202(1) transmitted by the BS 110. Note that, due to processing and transmission delays, there is latency between the transmission of the first subset 202(1) from the BS 110 and the receipt of the first subset 202(1) at the UE 120. From time t22 to time t23, the UE 120 employs DL decoding processing during time gap 204(1) to attempt to decode the PDSCH message. In this first scenario, the UE 120 fails to successfully decode the PDSCH message. As such, from time t23 to time t24, the UE 120 receives the second subset 202(2) transmitted by the BS 110. From time t24 to time t25, the UE 120 again attempts during time gap 204(2), but fails to decode the PDSCH message. As such, from time t25 to time t26, the UE 120 receives the third subset 202(3) transmitted by the BS 110 and, from time t26 to time t27, the UE 120 again attempts during time gap 204(3), but fails to decode the PDSCH message. As such, from time t27 to time t28, the UE 120 receives the fourth subset 202(4) transmitted by the BS 110 and, from time t28 to time t29, the UE 120 again attempts during time gap 204(4), but fails to decode the PDSCH message.

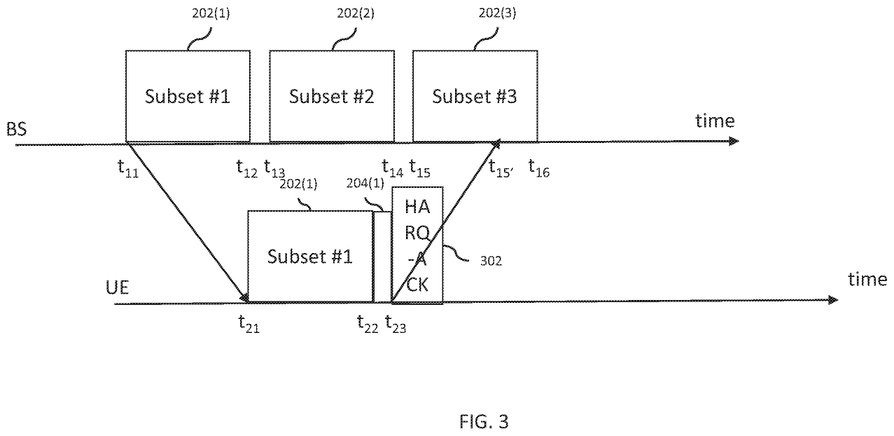

FIG. 3 is a time diagram representing the transmission of a PDSCH message by the BS 110 of FIG. 1 and the receipt and processing of that message by the UE 120 for a second scenario in which the UE 120 successfully decodes the PDSCH message before the BS 110 has finished transmitting all of its scheduled subsets for that PDSCH message. As shown in FIG. 3, from time t11 to time t15, the BS 110 performs the same processing as in FIG. 2. Similarly, from time t21 to time t23, the UE 120 performs the same processing as in FIG. 2, except, in this scenario, during time gap 204(1), the UE 120 successfully decodes the PDSCH message by time t23. In this situation, at or soon after time t23, the UE 120 switches from its DL operating mode to its UL operating mode and transmits a HARQ-ACK message 302 back to the BS 110 informing the BS 110 that the UE 120 has successfully decoded the PDSCH message.

The BS 110 receives and processes the HARQ-ACK message 302 starting at time t15′. In response, the BS 110 stops transmitting subsets for the PDSCH message. In the implementation represented in FIG. 3, the BS 110 completes the transmission of the current subset (i.e., the third subset 202(3)) before ceasing to transmit the PDSCH message. As such, in this scenario, the fourth subset 202(4) of FIG. 2 is not transmitted by the BS 110. Note that, due to latency, the BS 110 transmits the second and third subsets 202(2) and 202(3), but they are not received by the UE 120, which will be in its UL operating mode by the time those subsets arrive. Note that, because the BS 110 operates in a full-duplex mode, the BS 110 is able to (i) successfully receive and process the HARQ-ACK message 302 and (ii) transmit a subset to the UE 120 at the same time.

In other possible implementations, the BS 110 ceases transmitting the PDSCH message after receiving the HARQ-ACK message 302 at t15′ before completing the current subset, e.g., after completing the transmission of the current repetition of the PDSCH message even if it is not the last repetition in the current subset. Note that, if the BS 110 completes the processing of a HARQ-ACK message during a gap in time, the BS 110 can stop transmitting the PDSCH message without starting to transmit the next subset.

As suggested previously, in some implementations, there are no gaps in time between the different subsets of repetitions. In general, the base station 110 configures the UE 120 to receive the different subsets of repetitions and attempt to decode the PDSCH message at specified times. Depending on the implementation, these times could be specified in different ways, such as (without limitation) relative to the start of the set of repetitions, absolute (e.g., System Frame Number), every x'th repetition, or based on y ms/subframes before the scheduled UL resource. If the subsets are transmitted with gaps in time between them, then the base station 110 can configure the UE 120 to attempt to decode the PDSCH message during one or more of those gaps in time.

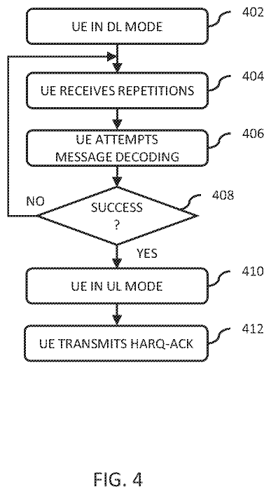

FIG. 4 is a flow diagram of the processing of the UE 120 of FIG. 1 according to certain implementations of the disclosure. In step 402, the UE 120 is configured in its DL operating mode. In step 404, the UE 120 receives one or more repetitions of a PDSCH message. In step 406, the UE attempts to decode the PDSCH message. If, in step 408, the UE determines that the PDSCH message was not successfully decoded, then processing returns to step 404 to receive for one or more repetitions of the PDSCH message. If, however, the PDSCH message was successfully decoded, then, in step 410, the UE 120 switches to its UL operating mode and, in step 412, the UE 120 transmits a HARQ-ACK message to the BS 110.

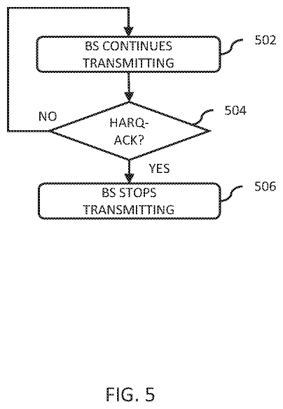

FIG. 5 is a flow diagram of the processing of the BS 110 of FIG. 1 according to certain implementations of the disclosure. In step 502, for a given PDSCH message, the BS 110 starts to transmit repetitions. If and when the BS 110 receives a HARQ-ACK message from the UE 120 at step 504, the BS 110 stops transmitting repetitions at step 506.

As described above, in the transmission sequence for a given PDSCH message, each subset includes one or more repetitions of the message and is possibly followed by a gap in time. The network (i.e., either the BS 110 or another network node) determines how many repetitions of the message to include in each subset, where the number of repetitions can vary for different subsets for a given PDSCH message and/or for different PDSCH messages.

For example, in one possible scenario, the BS 110 transmits the PDSCH message in a sequence of six subsets, where the first subset contains 50% of the repetitions, the second subset contains 25%, the third subset contains 10%, and the last three subsets each contain 5%. Thus, the timing (e.g., start time and duration) of the subsets and, if present, the timing of the gaps of time, are different for different subsets.

In general, the network can use the timing of the receipt of the HARQ-ACK messages relative to the corresponding phase of the transmission sequence as feedback for link adaptation (e.g., determining the number of subsets and/or the numbers of message repetitions to include in the subsets for subsequent PDSCH messages). Earlier receipt indicates relatively reliable decoding, which may imply the need for fewer message repetitions per subset and/or fewer subsets per sequence, and vice versa.

In general, when HARQ feedback processing is disabled, then the network cannot use HARQ feedback information as a reference for channel status to adjust the channel link parameter. Earlier feedback after the UE 120 successfully decode the DL PDSCH message can provide HARQ feedback information for link adaptation but without requiring additional latency since the feedback happens at the same time that the UE 120 is expected to receive the DL repetitions, although there is still no HARQ feedback after the completion of the entire repetition for the DL message.

Those skilled in the art will understand that the network may employ a Physical Downlink Control CHannel (PDCCH) and a Physical Uplink Control CHannel (PUCCH) to coordinate the communications between the BS 110 and the UE 120 and for the BS 110 to configure the UE 120 for the transmission sequences for different PDSCH messages. Alternatively, Radio Resource Control/Medium Access Control (RRC/MAC) signaling may be used.

In some implementations, the UE 120 uses a network-configured UL resource (e.g., frequency band and/or time) for transmission of HARQ-ACK messages. The resource may be linked to the decoding gaps in downlink transmission, such that, after decoding the DL message, the UE 120 can respond in UL. The UL resource may be shared by multiple UEs that multiplex their HARQ-ACK messages using, e.g., Code Doman Multiplex (CDM) processing, for more efficient use of the UL resource.

Although the disclosure has been described in the context of a UE that transmits a HARQ-ACK message immediately after successfully decoding a PDSCH message, those skilled in the art will understand that the disclosure can be implemented in the context of a UE that delays transmission of a HARQ-ACK message after successfully decoding a PDSCH message. In such an implementation, if the UE successfully decodes a PDSCH message after a current subset, then the UE may wait until one or more subsequent subsets are received for the PDSCH message before transmitting the HARQ-ACK message.

Although the disclosure has been described in the context of UEs that operate in a half-duplex mode in a network based on frequency division, those skilled in the art will understand that the disclosure can be implemented in the context of UEs that operate in a full-duplex mode and/or in a network based on time division.

Although the disclosure has been described in the context of PCSCH messages, those skilled in the art will understand that the disclosure can be implemented in the context of other types of messages.

The disclosure can be implemented in the context of a wireless Non Terrestrial Network (NTN) such as a 4G Internet of Things (IoT) NTN or a 5G New Radio (NR) NTN. Those skilled in the art will understand that the disclosure can be implemented in the context of other wireless networks as well as in wired or optical networks.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing the disclosure. When implemented on a general-purpose processor, the program code segments combine with the processor to provide a unique device that operates analogously to specific logic circuits.

The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

1.-19. (canceled)

20. User equipment (UE) comprising:
at least one processor; and
at least one memory storing instructions that, when executed by the at least one processor, cause the UE at least to:
while the UE is operating in half-duplex mode:
receive a set of repetitions of a downlink (DL) message, the set comprising two or more subsets of the repetitions;
attempt to decode the DL message after receiving one or more of the subsets;
based on the UE not successfully decoding the DL message in the one or more of the subsets: (i) do not transmit an uplink message indicating unsuccessful decoding of the DL message; and (ii) based on the set not being completed:
receive an additional two or more subsets, wherein a number of repetitions of the DL message is different for each of the additional two or more subsets of the repetitions; and
re-attempt to decode the DL message; and
based on the UE successfully decoding the DL message after the re-attempt, transmit an uplink (UL) message indicating successful decoding of the DL message, wherein the UE is configured to stop receiving repetitions of the DL message after successfully decoding the DL message, wherein the UE is configured to decode the DL message during a gap in time between a start and end of the additional two or more subsets, wherein the UL message is multiplexed with one or more other UL messages from one or more other UEs using a shared UL resource.

21. The UE of claim 20, wherein the UE is configured to attempt to decode the DL message based on one or more specified times.

22. The UE of claim 21, wherein the UE is configured with specified timing for the gap.

23. The UE of claim 22, wherein the UE is configured to use an UL resource to transmit the UL message.

24. The UE of claim 23, wherein the UL resource is configured as part of the configuring of the UE to receive the set of repetitions.

25. The UE of claim 24, wherein the UE transmits the UL message while repetitions of the DL message are arriving at the UE.

26. A system comprising:
a user equipment (UE);
at least one processor; and
at least one memory storing instructions that, when executed by the at least one processor, cause the UE at least to:
while the UE is operating in half-duplex mode:
receive a set of repetitions of a downlink (DL) message, the set comprising two or more subsets of the repetitions;
attempt to decode the DL message after receiving one or more of the subsets;
based on the UE not successfully decoding the DL message in the one or more of the subsets: (i) do not transmit an uplink message indicating unsuccessful decoding of the DL message; and (ii) based on the set not being completed:
receive an additional two or more subsets, wherein a number of repetitions of the DL message is different for each of the additional two or more subsets of the repetitions; and
re-attempt to decode the DL message; and
based on the UE successfully decoding the DL message after the re-attempt, transmit an uplink (UL) message indicating successful decoding of the DL message, wherein the UE is configured to stop receiving repetitions of the DL message after successfully decoding the DL message, wherein the UE is configured to decode the DL message during a gap in time between a start and end of the additional two or more subsets, wherein the UL message is multiplexed with one or more other UL messages from one or more other UEs using a shared UL resource.

27. The system of claim 26, wherein the UE is configured to attempt to decode the DL message based on one or more specified times.

28. The system of claim 27, wherein the UE is configured with specified timing for the gap.

29. The system of claim 28, wherein the UE is configured to use an UL resource to transmit the UL message.

30. The system of claim 29, wherein the UL resource is configured as part of the configuring of the UE to receive the set of repetitions.

31. The system of claim 30, wherein the UE transmits the UL message while repetitions of the DL message are arriving at the UE.

32. A method comprising:
receiving, at a user equipment (UE), a set of repetitions of a downlink (DL) message, the set comprising two or more subsets of the repetitions;
attempting to decode the DL message after receiving one or more of the subsets;
based on the UE not successfully decoding the DL message in the one or more of the subsets: (i) do not transmit an uplink message indicating unsuccessful decoding of the DL message; and (ii) based on the set not being completed:
receiving an additional two or more subsets, wherein a number of repetitions of the DL message is different for each of the additional two or more subsets of the repetitions; and
re-attempting to decode the DL message; and
based on the UE successfully decoding the DL message after the re-attempt, transmitting an uplink (UL) message indicating successful decoding of the DL message, wherein the UE is configured to stop receiving repetitions of the DL message after successfully decoding the DL message, wherein the UE is configured to decode the DL message during a gap in time between a start and end of the additional two or more subsets, wherein the UL message is multiplexed with one or more other UL messages from one or more other UEs using a shared UL resource.

33. The method of claim 32, wherein the UE is configured to attempt to decode the DL message based on one or more specified times.

34. The method of claim 33, wherein the UE is configured with specified timing for the gap.

35. The method of claim 34, wherein the UE is configured to use an UL resource to transmit the UL message.

36. The method of claim 35, wherein the UL resource is configured as part of the configuring of the UE to receive the set of repetitions.

37. The method of claim 36, wherein the UE transmits the UL message while repetitions of the DL message are arriving at the UE.
